(19) United States
(12) Patent Application Publication
(10) Pub. No.: US 2016/0150029 A1
(43) Pub. Date: May 26, 2016

(54) SERVICE DISCOVERY USING A LOCATION DATABASE

(71) Applicant: Avaya Inc., Santa Clara, CA (US)

(72) Inventors: Vivek L. ATREYA, Bangalore (IN); Shashi Hosakere ANKAIAH, Bangalore (IN); Poornima MUNIRAJAIAH, Bangalore (IN); Pavan Kumar Chikmagalur SIDDEGOWADA, Karnataka (IN)

(73) Assignee: Avaya Inc., Santa Clara, CA (US)

(21) Appl. No.: 14/555,313

(22) Filed: Nov. 26, 2014

(51) Int. Cl. H04L 29/08; G06F 17/30; H04W 4/02

(52) U.S. Cl. CPC H04L 67/16; H04W 4/02; G06F 17/3087; G06F 17/3053

(57) ABSTRACT

Methods, systems and computer readable media for building and using a location database for service discovery are described. In some implementations, the method can include detecting, at a location engine, a connection between a client and a new service within a wireless network, and receiving an RF fingerprint of the client. The method can also include determining a location of the client and the new service based on the RF fingerprint, and querying a location database using the RF fingerprint as a key. The method can further include determining whether a location database entry exists corresponding to the RF fingerprint. The method can also include, when there is no database entry corresponding to the RF fingerprint, adding a new record to the database corresponding to the RF fingerprint and the new service. The method can further include, when there is database entry corresponding to the RF fingerprint, computing a rank for the new service and updating the database entry corresponding to the RF fingerprint corresponding to the RF fingerprint.

### TECHNICAL FIELD

Embodiments relate generally to computer networks, and more particularly, to methods, systems and computer readable media for building and using a location database for service discovery.

### BACKGROUND

Service discovery protocol suites such as mDNS, UPnP/SSDP, LLMNR have helped make discovery of devices such as printers and display devices relatively easy. Further, using zero configuration protocols and systems, client devices such as phones, tablets, and laptops can discover available printers and display devices on a network. Technologies such as these may have begun in home and small office environments, but quickly spread to large enterprises, universities and schools.

These protocols may have been built to address service discovery within a relatively small network. Thus, these technologies may not scale well when applied within medium to large deployments. In turn, vendors began offering gateways to bridge service discovery across networks.

The bridging of service discovery across networks or running service discovery over flat single networks may have had another significant drawback in that client devices may discover and display to a user a large number of devices.

For example, in universities, each classroom may have an airplay unit to project to a larger screen. With tens to hundreds of such devices in a university, each device such as a phone/tablet may discover and display all of them to the user. Thus leading to a potentially bad user experience for an end user as the user may have to spend significant time reviewing the list to pick a device to connect to.

Similar experiences have been observed in enterprises, for example, where a number of printers are discovered and displayed to a user. The user may not be aware of the printer location and may end up submitting a print job to a printer in a different floor or wing.

Such situations led to the concept of location based service discovery. The gateways built to bridge service discovery traffic compared a client's location to the location of devices (e.g., a printer, a display or the like) to return services which were located relatively close the user. This method may depend on the availability of a client/device location engine/database. Two kinds of location databases have been used to power this feature. A first instance can include a real time location tracking system (RLTS), which can be a location application to determine the location of clients using algorithms such as RF fingerprinting, triangulation/trilateration. A second instance can include manually administered locations tags for access points and other devices of interest (e.g., printers, Airplay display devices or the like). An example of such a tag is the CBFS (Campus, Branch, Floor, Sector) tag, used by the Avaya WLAN 8100 made by Avaya Inc.

Both of the above approaches may have drawbacks, limitations or overhead, which have limited usage of location based service discovery and, in turn, service discovery itself in enterprise and other medium/large deployments.

Embodiments were conceived in light of the above mentioned needs, problems and/or limitations, among other things.

### SUMMARY

One or more embodiments can include methods, systems and computer readable media for building and using a location database for service discovery. In some implementations, the method can include detecting, at a location engine, a connection between a client and a new service within a wireless network, and receiving an RF fingerprint of the client. The method can also include determining a location of the client and the new service based on the RF fingerprint, and querying a location database using the RF fingerprint as a key. The method can further include determining whether a location database entry exists corresponding to the RF fingerprint. The method can also include, when there is no database entry corresponding to the RF fingerprint, adding a new record to the database corresponding to the RF fingerprint and the new service. The method can further include, when there is database entry corresponding to the RF fingerprint, computing a rank for the new service and updating the database entry corresponding to the RF fingerprint corresponding to the RF fingerprint.

The method can also include searching the location database using the RF fingerprint and a service type as a key value, and computing a distance between the RF fingerprint and each stored RF fingerprint of a corresponding record in the location database. The method can further include comparing each computed distance with a given distance threshold value, and, when the computed distance is within a given value, adding the corresponding record to a result set. The method can also include selecting a given number of records from the result set based on the computed distance. The method can further include providing, from the location engine, the given number of records to a gateway system.

The method can also include determining, at the gateway system, one or more service records corresponding to the given number of records from the location engine. The method can further include providing the one or more service records to a client device.

The RF fingerprint can include an RSSI fingerprint. The gateway system can include an mDNS gateway system. The one or more service records can include mDNS records.

Some implementations can include a system comprising one or more processors configured to perform operations. The operations can include detecting, at a location engine, a connection between a client and a new service within a wireless network. The operations can also include receiving an RF fingerprint of the client. The operations can further include determining a location of the client and the new service based on the RF fingerprint. The operations can also include querying a location database using the RF fingerprint as a key. The operations can further include determining whether a location database entry exists corresponding to the RF fingerprint. The operations can also include, when there is no database entry corresponding to the RF fingerprint, adding a new record to the database corresponding to the RF fingerprint and the new service. The operations can further include, when there is database entry corresponding to the RF fingerprint, computing a rank for the new service and updating the database entry corresponding to the RF fingerprint corresponding to the RF fingerprint.

The operations can also include searching the location database using the RF fingerprint and a service type as a key value. The operations can further include computing a distance between the RF fingerprint and each stored RF fingerprint of a corresponding record in the location database. The operations can also include comparing each computed distance with a given distance threshold value, and, when the computed distance is within a given value, adding the corresponding record to a result set. The operations can further include selecting a given number of records from the result set based on the computed distance. The operations can also include providing, from the location engine, the given number of records to a gateway system.

The operations can further include determining, at the gateway system, one or more service records corresponding to the given number of records from the location engine. The operations can also include providing the one or more service records to a client device.

The RF fingerprint can include an RSSI fingerprint. The gateway system can include an mDNS gateway system. The one or more service records can include mDNS records.

Some implementations can include a nontransitory computer readable medium having stored thereon software instructions that, when executed by one or more processors, cause the one or more processors to perform operations. The operations can include detecting, at a location engine, a connection between a client and a new service within a wireless network. The operations can also include receiving an RF fingerprint of the client. The operations can further include determining a location of the client and the new service based on the RF fingerprint. The operations can also include querying a location database using the RF fingerprint as a key. The operations can further include determining whether a location database entry exists corresponding to the RF fingerprint. The operations can also include, when there is no database entry corresponding to the RF fingerprint, adding a new record to the database corresponding to the RF fingerprint and the new service. The operations can further include, when there is database entry corresponding to the RF fingerprint, computing a rank for the new service and updating the database entry corresponding to the RF fingerprint corresponding to the RF fingerprint.

The operations can also include searching the location database using the RF fingerprint and a service type as a key value. The operations can further include computing a distance between the RF fingerprint and each stored RF fingerprint of a corresponding record in the location database. The operations can also include comparing each computed distance with a given distance threshold value, and, when the computed distance is within a given value, adding the corresponding record to a result set. The operations can further include selecting a given number of records from the result set based on the computed distance. The operations can also include providing, from the location engine, the given number of records to a gateway system.

The operations can further include determining, at the gateway system, one or more service records corresponding to the given number of records from the location engine. The operations can also include providing the one or more service records to a client device.

The RF fingerprint can include an RSSI fingerprint. The gateway system can include an mDNS gateway system. The one or more service records can include mDNS records.

### BRIEF DESCRIPTION OF THE DRAWINGS

FIG. 1 is a diagram of an example network environment for building and using a location database for service discovery in accordance with at least one implementation.

FIG. 2 is a flowchart of an example method of using a location database for service discovery in accordance with at least one implementation.

FIG. 3 is a flowchart of an example method of using a location database for service discovery in accordance with at least one implementation.

FIG. 4 is a diagram of an example network environment for building and using a location database for service discovery in accordance with at least one implementation.

FIG. 5 is a flow chart of an example method for building a location database for service discovery in accordance with at least one implementation.

FIG. 6 is a diagram of an example computer system for building and using a location database for service discovery in accordance with at least one implementation.

### DETAILED DESCRIPTION

In general, some implementations can include tagging a location (e.g., a location identified by an RF fingerprint gathered from client devices) with an automatically curated list of services and service instances preferences. A service can identify a service being requested or advertised (e.g., Airprint for printer, Airplay for Apple TV, or the like). Service instances can include a particular device offering the service (e.g., RightWing_Canon). The services and instances preferences at a location can be automatically gathered/curated by observing packet flows in the network. The preferences thus gathered can then be used to filter service instances shown to all users. Over time, preferences can be learned for an entire location, and used to recommend service instances during service discovery.

For a service to be discovered, the following example DNS records may be required: an SRV record, a TXT record and a PTR record. These record details can be stored at the mDNS gateway. These records can have a common instance name e.g., firstfloor_bay1_printer._ipp._tcp.local. So, the location database may only need the instance name and the RF fingerprint of the location from where the instance was accessed. With these two items, the location database can generate a score and when the mDNS gateway queries the location database for a service with the instance name, the location database can retrieve the nearest service with high score. The following are examples of Instance name, fingerprint and score information:

Service instance name: firstfloor_bay1_printer._ipp._tcp.local

Location fingerprint: 32

Score: 54

Service instance name: firstfloor_bay2_printer._ipp.local

Location Finger print: 62

Score: 65

Some implementations can include a location engine for powering location based service discovery. The location engine can maintain a database which can store information such as: RF fingerprint (e.g., RSSI fingerprint), service type, service instance, instance rank (or score), service DNS records and/or the like.

The location engine can interface (or connect) with systems providing mDNS gateway functionality. The location engine can interface with wireless control/management systems (e.g., of a WLAN) to gather client RF fingerprints.

In some implementations, using the location database for service discovery can include:

1) A client initiates service discovery, the gateway on the network handles the query, and hands it off to a location engine.

2) The location engine requests, from the wireless control/management system, the client device's fingerprint by sending an identifier of the client device (e.g., the mac address of the client device).

3) The wireless control/management system responds to the location engine with the client device's RF fingerprint (e.g., an RSSI fingerprint).

4) The location engine can issue a lookup request to the location database to return database entries (e.g., records) which lie close (e.g., have an RF fingerprint within a given ‘distance’) to the RSSI fingerprint specified in the query. The query to the location database can include, for example, the RSSI fingerprint and the service type. For example, a query could be formed as “select Service Score, Service ID where RSSI_fingerprint=‘30, 45, 55, 60’ & Service Type=‘AirPlay’”.

5) The location database can run a constrained/un-constrained search on its database using the RSSI fingerprint and the service type as the key. It can compute a distance (e.g., a Euclidian distance) between the RSSI fingerprint in the query and the fingerprints stored in the database. If the distance is within a specified range, the entry (or record) is added to the response set. The database can return the response set to the location engine. For example, “if compute_euclidian_distance(RSSI_Fingerprint_Key, RSSI_Fingerprint_DB)<=MAX_EUCLIDIAN_DIST && Service_Type_Key==Service_Type_DB then addRowToResponse (Service Instance, Instance rank, DNS records)”.

6) The location engine goes over the response set and picks a given number of top rank entries to return to the mDNS gateway.

7) The mDNS gateway then frames the mDNS response by adding DNS records for the chosen entries, and transmits the response to the client device.

In some implementations, building the location engine can include:

1) When new service instances are discovered by the mDNS gateway, the location engine can be notified by the gateway.

2) The location engine can fetch the IP address and port number being advertised by the service instance.

3) The location engine can request the wireless WLAN controller/management system to notify the location engine whenever a successful network flow is established with one or more of the specified destination port number, protocol, and IP address.

4) The Wireless Controller/management system then sets appropriate notification filters on access points.

5) When a client device establishes a connection with a service instance (e.g., a printer), the network flow hits, and the AP can notify the Wireless Controller/management system. The controller/management system captures the client RF fingerprint, and the flow details (e.g., destination IP, destination Port or the like), and notifies the location engine. Alternatively, a polling based approach can be performed. In the polling approach, the location engine can periodically poll data from the wireless controller/management application.

6) The location engine infers that the client device at location identified by the RSSI fingerprint has used the service instance identified by the destination IP.

7) The location engine uses the RSSI fingerprint as the key and queries the record to see if a row already exists with the RSSI fingerprint and service type. If a row already exists, then the location engine computes a rank (or score) for the service instance and updates the row in the location database. Service instances used frequently and recently rank higher. If no row exists for the RSSI fingerprint and service type combination in the location database, a new row is created with the service instance, and the computed rank. For example, if a user uses a wrong device then the device's score will increase by a little, as scores are increased gradually based on device usage. However, when the user starts using a better device then the score will decrease for the old device and increase for the new one. Since these scores are increased or decreased gradually, a wrong service used by a client may not noticeably change the score.

The ranking (or score) of a device or service may change over time. For example, if a particular service/device is not accessed for long time, its score may be gradually reduced up to a given lower threshold. Similarly, if a service is used more often, its score may be gradually increased up to a given upper threshold. So, over time for a particular RF range, the service which is used more often will have a higher score.

When comparing RSSI fingerprints, fingerprints within a Euclidian distance of a small constant can be treated as equal.

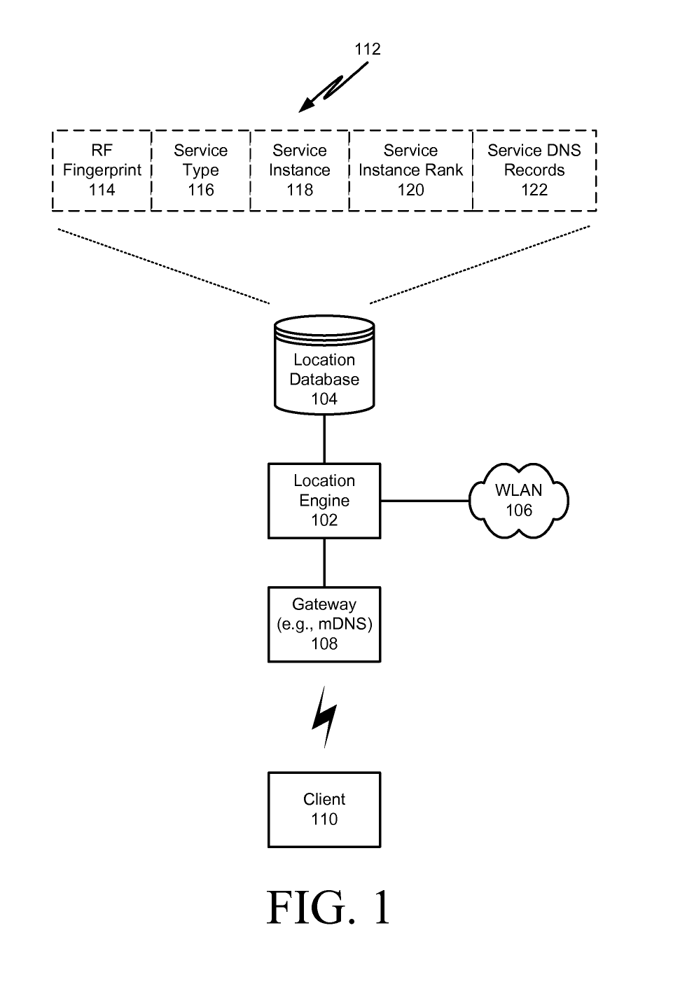

FIG. 1 is a diagram of an example network environment for building and using a location database for service discovery in accordance with at least one implementation. The environment can include a location engine 102, a location database 104, a network 106, a gateway 108 and one or more clients 110. The location database 104 can be configured to store one or more records 112. Each record 112 can include an RF fingerprint 114, a service type 116, a service instance 118, a service instance rank 120 and one or more service DNS records 122.

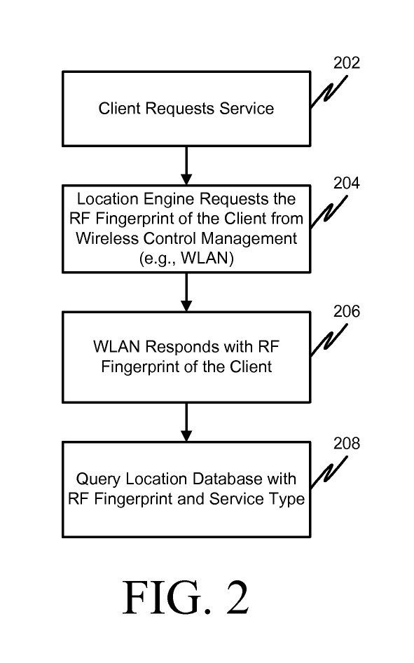

FIG. 2 is a flowchart of an example method of using a location database for service discovery in accordance with at least one implementation. Processing begins at 202, where a client requests a service. For example, client 110 could request a service type. Processing continues to 204.

At 204, a location engine requests the RF fingerprint from a wireless control/management system of the client requesting a service. For example, location engine 102 requests an RF fingerprint for client 110 from WLAN 106. Processing continues to 206.

At 206, the wireless control/management system responds with the RF fingerprint of the client. The RF fingerprint can include an RSSI fingerprint, for example. Processing continues to 208.

At 208, the location database is queried with the RF fingerprint and service type. For example, the location engine 102 could query the location database 103 using the RF fingerprint of the client 110 received from the WLAN 106 and the service type of the service requested by the client 110. It will be appreciated that 202-208 can be repeated in whole or in part.

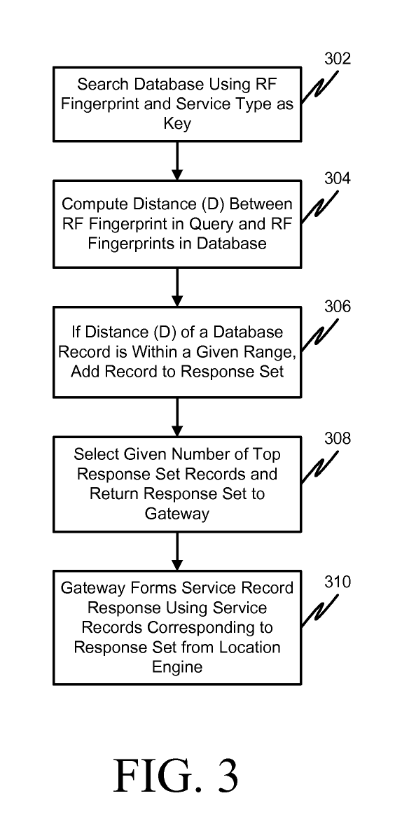

FIG. 3 is a flowchart of an example method of using a location database for service discovery in accordance with at least one implementation. Processing beings at 302, where a location database is searched using an RF fingerprint and a service type as a key. Processing continues to 304.

At 304, a distance (e.g., a Euclidian distance) is computed between the RF finger print key value and RF fingerprint values in the location database. Processing continues to 306.

At 306, if a distance of a stored record RF fingerprint is within a given range (e.g., plus or minus a threshold value) of the key RF fingerprint, the database record is added to a response set. Processing continues to 308.

At 308, a given number of top responses (e.g., the ten responses with a closest RF fingerprint and service type match) are returned to a gateway (e.g., an mDNS gateway) as a response set. Processing continues to 310.

At 310, the gateway forms a service record (e.g., mDNS record) response set based on the response set received from the location engine and sends the service record response set to the client device. It will be appreciated that 302-310 can be repeated in whole or in part.

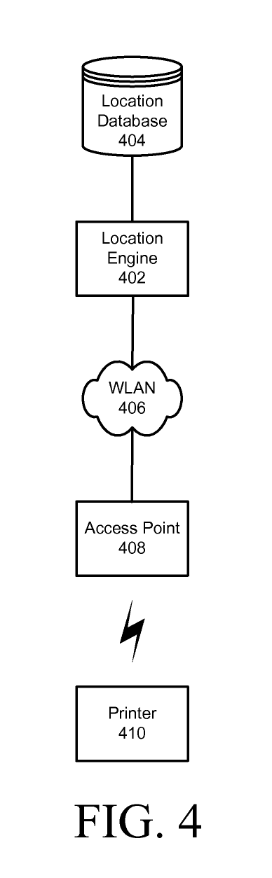

FIG. 4 is a diagram of an example network environment for building and using a location database for service discovery in accordance with at least one implementation. The environment includes a location engine 402, a location database 404, a WLAN 406, an access point 408 and a device providing a service (e.g., printer 410).

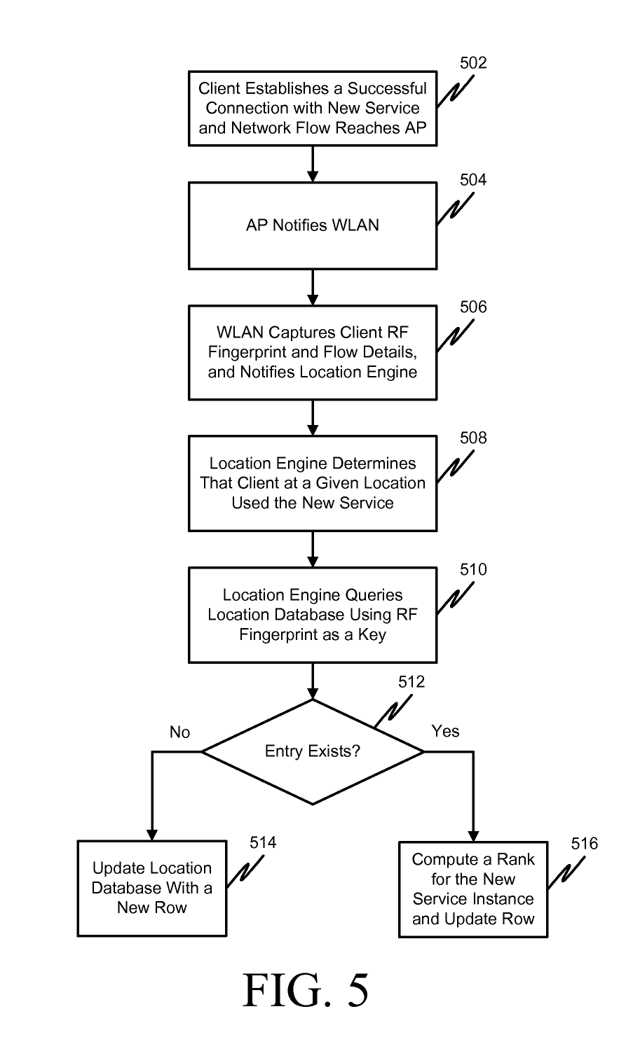

FIG. 5 is a flow chart of an example method for building a location database for service discovery in accordance with at least one implementation. Processing begins at 502, where a client establishes a successful connection with a new service. For example, a client may establish a successful connection with a service provided by printer 410. There is no mandatory requirement for an initial set of records in the database. To facilitate new clients, an initial training phase can be conducted to populate the location DB. Alternatively, the database can be built from scratch. When a service is requested by a client, any new service instance will be added to the location database with a default basic score. Over the time based on the usage, the score will change. Processing continues to 504.

At 504, an access point notifies the wireless network controller/management system that a successful connection was made between a client and the new service. Processing continues to 506.

At 506, the wireless controller/management system captures the RF fingerprint of the client and the flow details, and the wireless controller/management system notifies the location engine. Processing continues to 508.

At 508, the location engine determines that a client at a given location has used the new service. Processing continues to 510.

At 510, the location engine queries the location database using the RF fingerprint as a key. Processing continues to 512.

At 512, the location database determines whether an entry for the RF fingerprint exists. The determination can include an exact match of the RF fingerprint or a match within a given range of an RF fingerprint in the database. If there is no match for the RF fingerprint, processing continues to 514. If there is a match for the RF fingerprint, processing continues to 516.

At 514, the location database is updated with a new row (e.g., a new record is added) corresponding to the RF fingerprint.

At 516, a rank for the new service instance is computed and the row is updated with the rank. It will be appreciated that 502-516 can be repeated in whole or in part.

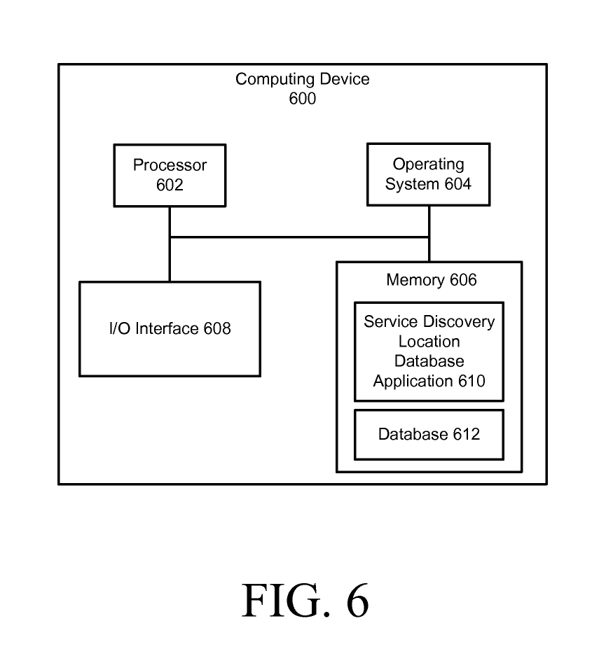

FIG. 6 is a diagram of an example computer system 600 in accordance with at least one implementation. The computer system 600 includes a processor 602, operating system 604, memory 606 and I/O interface 608. The memory 606 can include a location database for service discovery application 610 and a database 612 (e.g., for storing RF fingerprint information, service type information or the like).

In operation, the processor 602 may execute the application 610 stored in the memory 606. The application 610 can include software instructions that, when executed by the processor, cause the processor to perform operations for building and using a location database for service discovery in accordance with the present disclosure (e.g., performing one or more of steps 202-208, 302-310, and/or 502-516 described above). The application program 610 can operate in conjunction with the database 612 and the operating system 604.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for building and using a location database for service discovery.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
detecting, at a location engine, a connection between a client and a new service within a wireless network;
receiving an RF fingerprint of the client;
determining a location of the client and the new service based on the RF fingerprint;
querying a location database using the RF fingerprint as a key;
determining whether a location database entry exists corresponding to the RF fingerprint;
when there is no database entry corresponding to the RF fingerprint, adding a new record to the database corresponding to the RF fingerprint and the new service; and
when there is database entry corresponding to the RF fingerprint, computing a rank for the new service and updating the database entry corresponding to the RF fingerprint corresponding to the RF fingerprint.

2. The method of claim 1, further comprising:
searching the location database using the RF fingerprint and a service type as a key value;
computing a distance between the RF fingerprint and each stored RF fingerprint of a corresponding record in the location database;
comparing each computed distance with a given distance threshold value, and, when the computed distance is within a given value, adding the corresponding record to a result set;
selecting a given number of records from the result set based on the computed distance; and
providing, from the location engine, the given number of records to a gateway system.

3. The method of claim 2, further comprising:
determining, at the gateway system, one or more service records corresponding to the given number of records from the location engine; and
providing the one or more service records to a client device.

4. The method of claim 1, wherein the RF fingerprint includes an RSSI fingerprint.

5. The method of claim 2, wherein the gateway system is an mDNS gateway system.

6. The method of claim 3, wherein the one or more service records include mDNS records.

7. A system comprising one or more processors configured to perform operations including:
detecting, at a location engine, a connection between a client and a new service within a wireless network;
receiving an RF fingerprint of the client;
determining a location of the client and the new service based on the RF fingerprint;
querying a location database using the RF fingerprint as a key;
determining whether a location database entry exists corresponding to the RF fingerprint;
when there is no database entry corresponding to the RF fingerprint, adding a new record to the database corresponding to the RF fingerprint and the new service; and
when there is database entry corresponding to the RF fingerprint, computing a rank for the new service and updating the database entry corresponding to the RF fingerprint corresponding to the RF fingerprint.

8. The system of claim 7, wherein the operations further comprise:
searching the location database using the RF fingerprint and a service type as a key value;
computing a distance between the RF fingerprint and each stored RF fingerprint of a corresponding record in the location database;
comparing each computed distance with a given distance threshold value, and, when the computed distance is within a given value, adding the corresponding record to a result set;
selecting a given number of records from the result set based on the computed distance; and
providing, from the location engine, the given number of records to a gateway system.

9. The system of claim 8, wherein the operations further comprise:
determining, at the gateway system, one or more service records corresponding to the given number of records from the location engine; and
providing the one or more service records to a client device.

10. The system of claim 7, wherein the RF fingerprint includes an RSSI fingerprint.

11. The system of claim 8, wherein the gateway system is an mDNS gateway system.

12. The system of claim 9, wherein the one or more service records include mDNS records.

13. A nontransitory computer readable medium having stored thereon software instructions that, when executed by one or more processors, cause the one or more processors to perform operations including:
detecting, at a location engine, a connection between a client and a new service within a wireless network;
receiving an RF fingerprint of the client;
determining a location of the client and the new service based on the RF fingerprint;
querying a location database using the RF fingerprint as a key;
determining whether a location database entry exists corresponding to the RF fingerprint;
when there is no database entry corresponding to the RF fingerprint, adding a new record to the database corresponding to the RF fingerprint and the new service; and
when there is database entry corresponding to the RF fingerprint, computing a rank for the new service and updating the database entry corresponding to the RF fingerprint corresponding to the RF fingerprint.

14. The nontransitory computer readable medium of claim 13, wherein the operations further comprise:
searching the location database using the RF fingerprint and a service type as a key value;
computing a distance between the RF fingerprint and each stored RF fingerprint of a corresponding record in the location database;
comparing each computed distance with a given distance threshold value, and, when the computed distance is within a given value, adding the corresponding record to a result set;
selecting a given number of records from the result set based on the computed distance; and
providing, from the location engine, the given number of records to a gateway system.

15. The nontransitory computer readable medium of claim 14, wherein the operations further comprise:
determining, at the gateway system, one or more service records corresponding to the given number of records from the location engine; and
providing the one or more service records to a client device.

16. The nontransitory computer readable medium of claim 13, wherein the RF fingerprint includes an RSSI fingerprint.

17. The nontransitory computer readable medium of claim 14, wherein the gateway system is an mDNS gateway system.

18. The nontransitory computer readable medium of claim 15, wherein the one or more service records include mDNS records.
